(19) United States
(12) Patent Application Publication
(10) Pub. No.: US 2017/0185763 A1
(43) Pub. Date: Jun. 29, 2017

(54) CAMERA-BASED DETECTION OF OBJECTS PROXIMATE TO A VEHICLE

(71) Applicant: Faraday&Future Inc., Gardena, CA (US)

(72) Inventors: Oliver Max JEROMIN, Holland, MI (US); Hong S. BAE, Torrance, CA (US)

(21) Appl. No.: 15/390,418

(22) Filed: Dec. 23, 2016

Related U.S. Application Data
(60) Provisional application No. 62/272,583, filed on Dec. 29, 2015.

(51) Int. Cl. G06F 21/32; G06T 7/50; G06T 7/20; H04N 7/18; G06K 9/00

(52) U.S. Cl. CPC G06F 21/32; H04N 7/181; G06K 9/00805; G06T 7/20; G06T 7/50; G06K 9/00288; G06T 2207/30261; G06T 2207/10028; G06F 2221/2117

(57) ABSTRACT

A system is disclosed. The system comprises one or more processors, and a memory including instructions, which when executed by the one or more processors, cause the one or more processors to perform a method. The method includes receiving image data from a first camera mounted on a vehicle, the vehicle including an element configured to open into a space external to the vehicle, and the image data indicative of a motion of the first camera with respect to an environment of the vehicle. Whether an object, external to the vehicle, will interfere with the opening of the element into the space is determined, the determination based on the motion, indicated in the image data, of the first camera with respect to the environment of the vehicle.

### CROSS REFERENCE TO RELATED APPLICATION

This application claims the benefit of U.S. Provisional Patent Application No. 62/272,583, filed on Dec. 29, 2015, the entire disclosure of which is incorporated herein by reference in its entirety for all intended purposes.

### FIELD OF THE DISCLOSURE

This relates generally to camera-based object detection, and more particularly, to detecting objects using one or more cameras on a vehicle to prevent the opening of a door into the objects.

### BACKGROUND OF THE DISCLOSURE

Modern vehicles, especially automobiles, increasingly include various sensors for detecting and gathering information about the vehicles' surroundings. These sensors may include ultrasonic sensors for detecting the proximity of a vehicle to objects in the vehicle's surroundings. However, ultrasonic sensors may have limited accuracy in certain situations, such as when the objects are relatively close to the sensors. Therefore, an alternative solution to object detection can be desirable.

### SUMMARY OF THE DISCLOSURE

Examples of the disclosure are directed to using one or more cameras to detect objects in proximity to a vehicle. In some examples, the vehicle determines whether those objects will interfere with the opening of one or more doors on the vehicle, and if they will, prevents the opening of the doors into those objects. In some examples, the cameras can be rear-facing or side-facing, and in some examples, the cameras can be mounted to the doors of the vehicle.

### BRIEF DESCRIPTION OF THE DRAWINGS

FIG. 1 illustrates an exemplary vehicle having two doors according to examples of the disclosure.

FIG. 2 illustrates an exemplary vehicle having two rear-facing cameras according to examples of the disclosure.

FIG. 3 illustrates an exemplary vehicle having a side-facing camera according to examples of the disclosure.

FIGS. 4A-4B illustrate an exemplary vehicle having cameras mounted on doors according to examples of the disclosure.

FIG. 5 illustrates a system block diagram according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

Some vehicles, such as automobiles, may include ultrasonic sensors for detecting the proximity of the vehicles to objects in the vehicles' surroundings. However, ultrasonic sensors may have limited accuracy in certain situations, such as when the objects are relatively close to the sensors. Examples of the disclosure are directed to using one or more cameras to detect objects in proximity to a vehicle. In some examples, the vehicle determines whether those objects will interfere with the opening of one or more doors on the vehicle, and if they will, prevents the opening of the doors into those objects. In some examples, the cameras can be rear-facing or side-facing, and in some examples, the cameras can be mounted to the doors of the vehicle. Further, in some examples, the camera-based object detection of the disclosure can be used in conjunction with other sensors on the vehicle (e.g., ultrasonic sensors, radar sensors, etc.) to improve the accuracy of object detection. For example, object detection information from multiple systems can be processed and/or combined (e.g., averaged) by the vehicle to determine object location(s). In some examples, the vehicle can switch between different types of object-detection systems (e.g., camera, ultrasonic, radar) based on which type of system will likely provide the most accurate object detection results (e.g., due to weather conditions, vehicle speed, etc.).

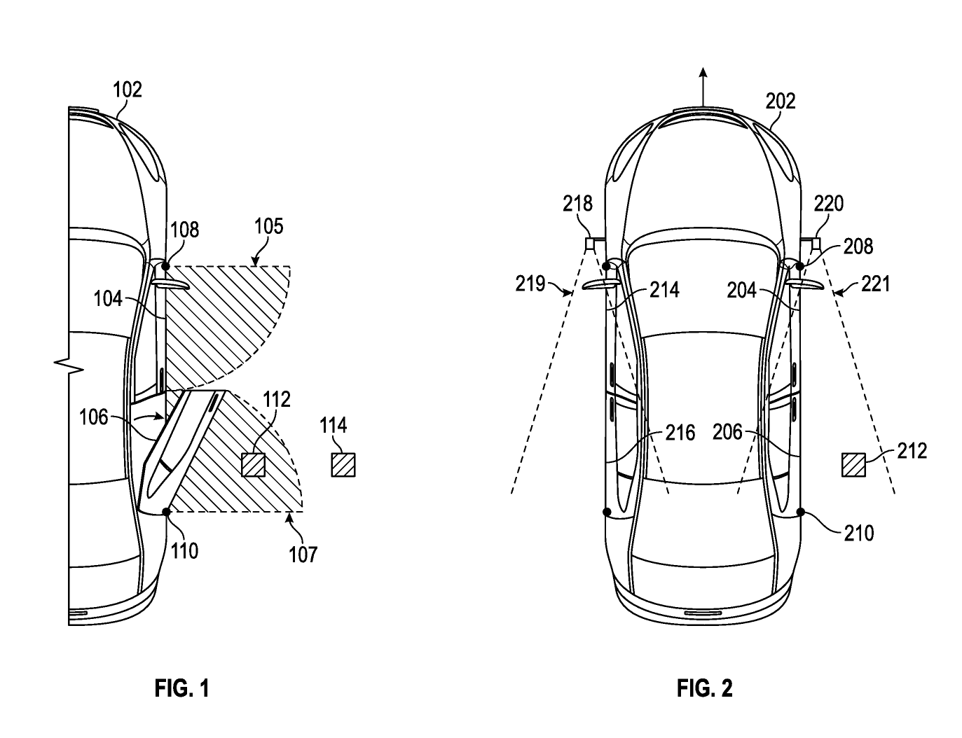

FIG. 1 illustrates exemplary vehicle 102 having doors 104 and 106 according to examples of the disclosure. Vehicle 102 can be any vehicle, such as an automobile, bus, truck, van, airplane, boat, and so on. A right-half of vehicle 102 is illustrated in FIG. 1, though it is understood that the vehicle can include a left-half as well. Vehicle 102 can include one or more elements that can open into a space external to the vehicle. For example, vehicle 102 can include doors 104 and 106 that can be coupled to the vehicle via hinges 108 and 110, respectively. Interaction spaces 105 and 107 can be spaces, external to vehicle 102, into which doors 104 and 106, respectively, can open. Although FIG. 1 illustrates a vehicle having two doors on each side, it should be understood that the disclosed systems and methods can also be adopted on vehicles with a different number of doors (e.g., one door on each side). The examples of the disclosure will be described in the context of doors, though it is understood that the examples of the disclosure can be implemented in the context of any element on vehicle 102 that can open into a space external to the vehicle, such as hoods, trunk lids, windows, gas cap access covers, side view mirrors, etc.

It can be beneficial for one or more systems on vehicle 102 to determine whether an object will interfere with the opening of doors 104 and/or 106 (e.g., a full opening of doors 104 and/or 106). For example, if doors 104 and/or 106 are automatic doors (e.g., if the doors open, using motors, in response to a user command (e.g., pressing of a button or being within a certain proximity of the door or a door handle) to open the doors), and if an object will interfere with the opening of doors 104 and/or 106, vehicle 102 can determine to provide a warning to an operator of the vehicle about the interfering object, prevent the opening of doors 104 and/or 106, and/or only open doors 104 and/or 106 to the extent permitted by the interfering object (e.g., only open door 106 halfway). If doors 104 and/or 106 are manual doors (e.g., if the doors are opened by hand), vehicle 102 can simply allow doors 104 and/or 106 to open freely (i.e., the object-avoidance system can be fully disabled), determine to provide a warning to an operator of the vehicle about the interfering object (i.e., the object-avoidance system can be partially disabled), prevent the opening of doors 104 and/or 106 (e.g., by locking the doors or the door opening mechanism, or providing resistance against opening the doors), and/or only allow doors 104 and/or 106 to open to the extent permitted by the interfering object.

In some examples, vehicle 102 can determine whether an object will interfere with the opening of one or more of doors 104 and 106 by determining whether the object is within interaction spaces 105 and 107, respectively. For example, referring to FIG. 1, vehicle 102 can determine that object 112 (e.g., a wall, a pillar, a tree, a parking meter, etc.) is within interaction space 107 of door 106. Thus, vehicle 102 can determine that object 112 will interfere with the opening of door 106, and the vehicle can determine an appropriate response, as detailed above. In contrast, vehicle 102 can determine that object 114 is not within interaction space 107 (nor any other interaction spaces), and thus will not interfere with the opening of door 106 (or any other door). Similarly, vehicle 102 can determine that no object is within interaction space 105 of door 104, and thus can allow door 104 to open freely.

The vehicle of the disclosure can determine whether one or more objects will interfere with the opening of one or more doors by using one or more optical cameras, as will be discussed below. In particular, the examples of the disclosure need not be reliant on the availability of image data from two or more cameras, but rather can be implemented using image data from a single camera.

FIG. 2 illustrates exemplary vehicle 202 having rear-facing cameras 218 and 220 according to examples of the disclosure. The front of vehicle 202 can be oriented towards the top of the page. Similar to vehicle 102 in FIG. 1, vehicle 202 in FIG. 2 can have right-hand doors 204 and 206, and left-hand doors 214 and 216. Additionally, vehicle 202 can have right-hand camera 220 and left-hand camera 218. Cameras 218 and 220 can be any type of camera, such as visible light cameras, infrared cameras, ultraviolet cameras, etc.

Camera 220 can be mounted on the front half of vehicle 202 (e.g., in front of door 204), and can be rear-facing. In some examples, camera 220 can be mounted on or near the right-hand A-Pillar of vehicle 202. Camera 220 can have field of view 221, which can encompass at least a portion of the interaction spaces of doors 204 and 206 (not shown). In some examples, field of view 221 can also encompass a portion of vehicle 202 (e.g., doors 204 and 206, hinges 208 and 210, door handles (not shown), wheel wells (not shown), any portion of the vehicle chassis, etc.). In some examples, camera 220 can replace a traditional side view mirror on vehicle 202, by displaying an image of what is included in field of view 221 on a display (e.g., LCD, OLED, etc.) in vehicle 202. In some examples, camera 220 can be used to perform blind-spot monitoring on the right side of vehicle 202.

Camera 220 can also be utilized to determine whether an object (e.g., object 212) will interfere with the opening of one or more of doors 204 and 206 (e.g., by determining whether the object is within the interaction spaces of doors 204 and/or 206, as previously described). In particular, vehicle 202 can, based on the movement of the vehicle (and thus camera 220) with respect to object 212, determine a relative location of the object with respect to the vehicle, as will be described in more detail below. Because vehicle 202 can know the interaction spaces of doors 204 and 206 before the above determination is made, the vehicle can compare the determined relative location of object 212 to the interaction spaces of doors 204 and 206 to determine whether the object is within one or more of those interaction spaces. In some examples, the interaction spaces of doors 204 and 206 can be stored in a memory in vehicle 202 prior to the above-described determinations being made (e.g., when vehicle 202 is manufactured, or during a calibration procedure performed after manufacture of the vehicle).

Vehicle 202 can use any suitable method(s) for determining the relative location of object 212 using camera 220, such as “depth from motion” (or “structure from motion”) algorithms. In depth from motion algorithms, the relative locations of one or more objects in the field of view of a single camera can be determined by comparing the positions of the objects, in images captured by the camera, at multiple instances of time between which the camera has moved with respect to the objects. Exemplary depth from motion algorithms are described in U.S. Pat. No. 8,837,811, entitled “Multi-stage linear structure from motion,” the contents of which is hereby incorporated by reference for all purposes. Because camera 220 can be mounted to vehicle 202, as previously described, a depth from motion map of the vehicle's surroundings visible to camera 220 can be determined while the vehicle is moving. For example, if vehicle 202 is moving with respect to object 212, a depth of motion map can be generated that indicates the position of object 212, from which the vehicle can determine whether object 212 will interfere with the opening of one or both of doors 204 and 206. Analogously to what is described above, vehicle 202 can utilize camera 218 to determine whether an object will interfere with the opening of one or both of doors 214 and 216.

In some examples, cameras 218 and 220 can be mounted on vehicle 202 at known locations on the vehicle (e.g., known positions, heights, orientations, etc.). Further, the speed of vehicle 202 can be known to the vehicle. Thus, when making the determinations about the location(s) of object(s) in vehicle's 202 surroundings, one or more of these known quantities can be used by the vehicle to increase the accuracy of the depth from motion maps as compared with situations where camera speed and/or location may not be known. In other words, one or more of the known location of the cameras and the known speed of the vehicle, for example, can be used to determine the location of objects relative to vehicle 202. Additionally, as discussed above, in some examples, a portion of vehicle 202 can be included in the fields of view of cameras 218 and/or 220. Thus, vehicle 202 can identify known reference points captured in the cameras' fields of view, and can use known dimensions corresponding to those reference points to more accurately determine the depth from motion maps (and thus the locations of objects relative to the vehicle). For example, hinge 210 and the rear-right wheel (not shown) of vehicle 202 can be in field of view 221 of camera 220. Further, vehicle 202 can know the distance between hinge 210 and the rear-right wheel (e.g., the distance can be stored in a memory). Using this reference distance, vehicle 202 can more accurately determine the location of object 212 with respect to the vehicle (and, for example, whether the object is within the interaction spaces of doors 204 and 206). Further, in some examples, vehicle 202 can utilize the known reference dimensions of various portions of the vehicle in field of view 221 as reference points for performing auto-calibration of the depth from motion determinations described in this disclosure.

In some examples, the depth from motion maps discussed above can be generated whenever vehicle 202 is in motion; when an input for opening a door is received (e.g., after the vehicle comes to a stop), the last-generated depth from motion map can be utilized to determine whether an object will prevent opening of any of doors 204, 206, 214 and 216. In other examples, the depth from motion maps can be determined only after vehicle 202 determines that it will likely come to a stop within a threshold amount of time (e.g., 1 second, 5 seconds, 10 seconds, etc.), which can be based on an assumption that the doors of the vehicle are unlikely to be opened while the vehicle is in motion. In this way, vehicle 202 may avoid generating depth from motion maps when traveling at relatively constant speeds on a freeway or a road, for example. In such examples, once vehicle 202 determines that it will likely come to a stop, generation of the depth from motion maps can be triggered such that the maps can be ready when the vehicle is stopped and a door is being—or, is requested to be—opened. In some examples, vehicle 202 can determine that it will likely come to a stop within a threshold amount of time if the vehicle slows down below a threshold speed (e.g., 5 mph, 10 mph, etc.) or is decelerating above a threshold deceleration rate from an initial detected speed of travel. In some examples, the depth from motion maps may be generated only after vehicle 202 actually does stop, at which time the vehicle can process past image data from cameras 218 and/or 220 (e.g., last 5 seconds, last 10 seconds, etc., worth of images, stored in a memory) to determine the depth from motion maps.

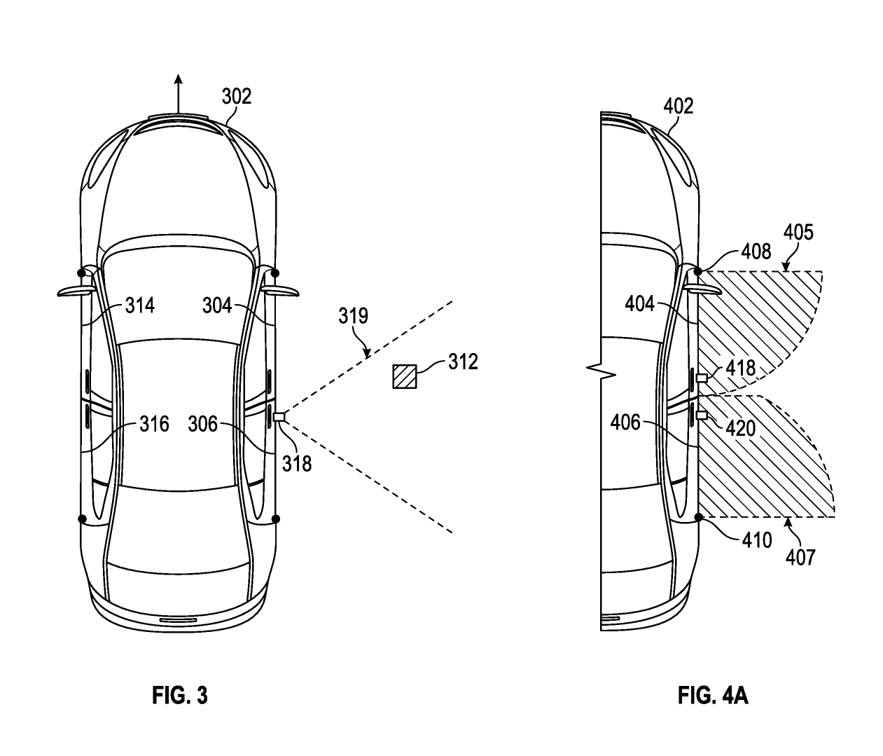

FIG. 3 illustrates exemplary vehicle 302 having side-facing camera 318 according to examples of the disclosure. The front of vehicle 302 can be oriented towards the top of the page. Similar to vehicle 102 in FIG. 1, vehicle 302 in FIG. 3 can have right-hand doors 304 and 306, and left-hand doors 314 and 316. Additionally, vehicle 302 can have right-hand camera 318. Vehicle 302 can additionally or alternatively have a left-hand camera, though such a camera is not illustrated for simplicity of discussion. The discussion provided below with respect to right-hand camera 318 can apply analogously to a left-hand camera, if included in vehicle 302. Camera 318 can be any type of camera, such as a visible light camera, infrared camera, ultraviolet camera, etc.

Camera 318 can be mounted on the right side of vehicle 302, such as on one of doors 304 and 306, or another structure of the vehicle, and can be side-facing. Camera 318 can have field of view 319, which can encompass at least a portion of the interaction spaces of doors 304 and 306 (not shown). In some examples, camera 318 can be used to identify a user (e.g., via biometric facial recognition) and provide access to vehicle 302 upon successful identification of the user and determination that the user is authorized to access the vehicle.

Camera 318 can also be utilized to determine whether an object (e.g., object 312) will interfere with the opening of one or more of doors 304 and 306 (e.g., by determining whether the object is within the interaction spaces of doors 304 and/or 306, as previously described). In particular, vehicle 302 can, based on the movement of the vehicle (and thus camera 318) with respect to object 312, determine a relative location of the object with respect to the vehicle using depth from motion techniques, as described above. Because vehicle 302 can know the interaction spaces of doors 304 and 306 before the above determination is made, the vehicle can compare the determined relative location of object 312 to the interaction spaces of doors 304 and 306 to determine whether the object is within one or more of those interaction spaces. In some examples, the interaction spaces of doors 304 and 306 can be stored in a memory in vehicle 302 prior to the above-described determinations being made (e.g., when vehicle 302 is manufactured, or during a calibration procedure performed after manufacture of the vehicle). Other details about the operation of camera 318 in determining whether objects will interfere with the opening of doors 304 and/or 306, such as how or when such determination are made, can be analogous to as discussed above with respect to FIGS. 1-2, and will not be repeated here for brevity.

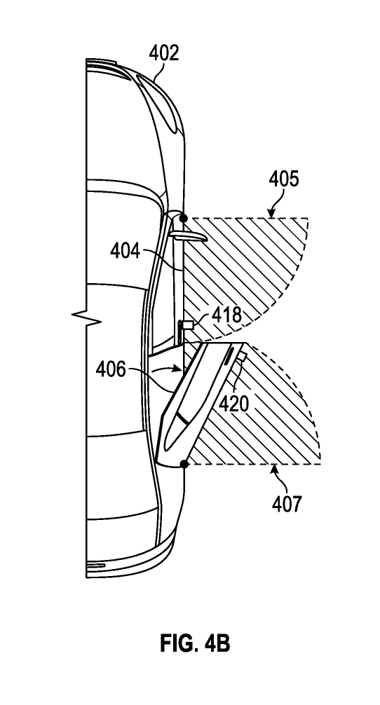

The depth from motion determinations of the examples of FIGS. 2 and 3 can rely, for the most part, on the motion of the vehicle on which the camera(s) are mounted. However, in some examples, the camera(s) can be mounted on the doors themselves, and the motion of the doors, as they open, can provide the requisite camera-motion with respect to objects in the environment of the vehicle for making the depth from motion determinations of the disclosure. FIGS. 4A-4B illustrate exemplary vehicle 402 having cameras 418 and 420 mounted on doors 404 and 406, respectively, according to examples of the disclosure. In FIG. 4A, vehicle 402 can have doors 404 and 406. Camera 418 can be mounted on door 404, and camera 420 can be mounted on door 406. In some examples, cameras 418 and 420 can be mounted on the ends of doors 404 and 406 opposite hinges 408 and 410, respectively, though in some examples, cameras 418 and 420 can be mounted anywhere on doors 404 and 406, respectively.

In some examples, cameras 418 and 420 can be utilized similar to as described with reference to FIGS. 2-3 to determine whether objects will interfere with the opening of doors 404 and 406—that is, movement of cameras 418 and 420 with respect to objects in the surroundings of vehicle 402 can be provided by movement of the vehicle, itself. However, in some examples, in addition or alternatively to the operation described with reference to FIGS. 2-3, cameras 418 and 420 can determine object positions based on movement of doors 404 and 406, rather than movement of vehicle 402 as a whole. For example, vehicle 402 may be stopped. While vehicle 402 is stopped, door 406 may be requested to be opened (e.g., by a user command or input, such as a button press), or may be manually opened by a user. Consequently, door 406 can begin to open, as illustrated in FIG. 4B. As a result of door 406 opening, camera 420 mounted on door 406 can move in accordance with the opening of door 406. Once door 406 begins to open, because camera 420 can be moving, and presumably moving with respect to objects in the surroundings of vehicle 402, a depth from motion map can be generated using camera 420 in the manner(s) previously described. This depth from motion map can be utilized by vehicle 402 to prevent the opening of door 406 into an object in interaction space 407, as previously described. In some examples, if vehicle 402 perceives that an object is moving towards camera 420 as door 406 is opening, the vehicle can abort its door opening sequence. The above discussion can apply analogously to door 404 and corresponding camera 418.

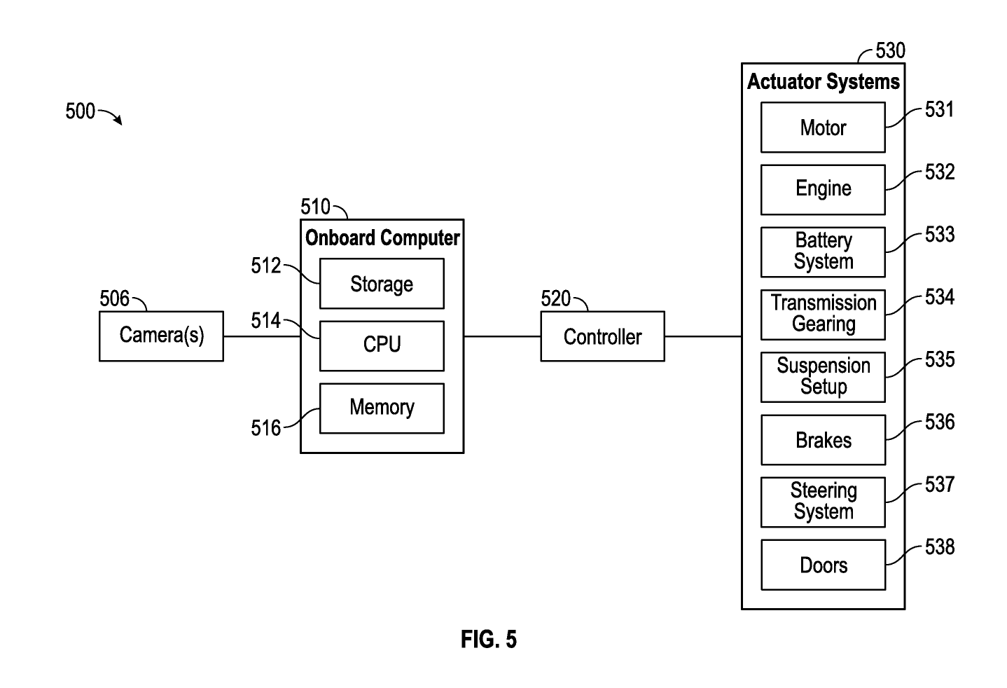

FIG. 5 illustrates a system block diagram according to examples of the disclosure. Vehicle control system 500 can perform any of the methods described with reference to FIGS. 1-4. System 500 can be incorporated into a vehicle, such as a consumer automobile. Other example vehicles that may incorporate the system 500 include, without limitation, airplanes, boats, or industrial automobiles. Vehicle control system 500 can include one or more cameras 506 capable of capturing image data (e.g., video data), as previously described. Vehicle control system 500 can include an on-board computer 510 coupled to the cameras 506, and capable of receiving the image data from the camera and determining whether one or more objects in the image data will interfere with the opening of one or more doors of the vehicle, and with which doors the objects will interfere, as described in this disclosure. On-board computer 510 can include storage 512, memory 516, and a processor 514. Processor 514 can perform any of the methods described with reference to FIGS. 1-4. Additionally, storage 512 and/or memory 516 can store data and instructions for performing any of the methods described with reference to FIGS. 1-4. Storage 512 and/or memory 516 can be any non-transitory computer readable storage medium, such as a solid-state drive or a hard disk drive, among other possibilities. The vehicle control system 500 can also include a controller 520 capable of controlling one or more aspects of vehicle operation, such as moving the vehicle or controlling door operation based on the determinations of the on-board computer 510.

In some examples, the vehicle control system 500 can be connected to (e.g., via controller 520) one or more actuator systems 530 in the vehicle. The one or more actuator systems 530 can include, but are not limited to, a motor 531 or engine 532, battery system 533, transmission gearing 534, suspension setup 535, brakes 536, steering system 537 and door system 538. Based on the determined locations of one or more objects relative to the interaction spaces of doors 538, the vehicle control system 500 can control one or more of these actuator systems 530 to prevent the opening of a door into one of the objects. This can be done by, for example, controlling operation of doors 538 as discussed in this disclosure. As another example, the vehicle control system 500 can move the vehicle, such that the door to be opened will be free to open, by adjusting the steering angle and engaging the drivetrain (e.g., motor) to move the vehicle at a controlled speed. The camera system 506 can continue to capture images and send them to the vehicle control system 500 for analysis, as detailed in the examples above. The vehicle control system 500 can, in turn, continuously or periodically send commands to the one or more actuator systems 530 to prevent the opening of a door into one of the objects.

Thus, the examples of the disclosure provide various ways to prevent the opening of a vehicle door into an object using one or more cameras.

Therefore, according to the above, some examples of the disclosure are directed to a system comprising: one or more processors; and a memory including instructions, which when executed by the one or more processors, cause the one or more processors to perform a method comprising: receiving image data from a first camera mounted on a vehicle, the vehicle including an element configured to open into a space external to the vehicle, and the image data indicative of a motion of the first camera with respect to an environment of the vehicle; and determining whether an object, external to the vehicle, will interfere with the opening of the element into the space, the determination based on the motion, indicated in the image data, of the first camera with respect to the environment of the vehicle. Additionally or alternatively to one or more of the examples disclosed above, in some examples, the element comprises a door configured to open into an interaction space external to the vehicle. Additionally or alternatively to one or more of the examples disclosed above, in some examples, determining whether the object will interfere with the opening of the element into the space comprises: generating a depth from motion map of the environment of the vehicle using the image data, the depth from motion map including the object; in accordance with a determination that the object, in the depth from motion map, is within the space into which the element is configured to open, determining that the object will interfere with the opening of the element into the space; and in accordance with a determination that the object, in the depth from motion map, is not within the space into which the element is configured to open, determining that the object will not interfere with the opening of the element into the space. Additionally or alternatively to one or more of the examples disclosed above, in some examples, generating the depth from motion map comprises: in accordance with a determination that the vehicle will likely stop within a time threshold, generating the depth from motion map; and in accordance with a determination that the vehicle will not likely stop within the time threshold, forgoing generating the depth from motion map. Additionally or alternatively to one or more of the examples disclosed above, in some examples, generating the depth from motion map comprises: in accordance with a determination that the vehicle is stopped, generating the depth from motion map using the image data from before the vehicle stopped; and in accordance with a determination that the vehicle is not stopped, forgoing generating the depth from motion map. Additionally or alternatively to one or more of the examples disclosed above, in some examples, the first camera is substantially rear-facing on the vehicle. Additionally or alternatively to one or more of the examples disclosed above, in some examples, the first camera is substantially side-facing on the vehicle. Additionally or alternatively to one or more of the examples disclosed above, in some examples, the first camera is mounted to the element, and the motion of the first camera with respect to the environment is due to the opening of the element, independent of a movement of the vehicle. Additionally or alternatively to one or more of the examples disclosed above, in some examples, the motion of the first camera with respect to the environment is due to a movement of the vehicle. Additionally or alternatively to one or more of the examples disclosed above, in some examples, the first camera is additionally used as a side-view mirror replacement. Additionally or alternatively to one or more of the examples disclosed above, in some examples, the first camera is additionally used for facial recognition to grant a user access to the vehicle. Additionally or alternatively to one or more of the examples disclosed above, in some examples, the method further comprises: in accordance with a determination that the object will interfere with the opening of the element into the space, preventing the opening of the element; and in accordance with a determination that the object will not interfere with the opening of the element into the space, allowing the opening of the element. Additionally or alternatively to one or more of the examples disclosed above, in some examples, the method further comprises: detecting user input for opening the element; in response to detecting the user input: in accordance with a determination that the object will interfere with the opening of the element into the space, partially opening the element into the space to the extent allowed by the object; and in accordance with a determination that the object will not interfere with the opening of the element into the space, fully opening the element into the space. Additionally or alternatively to one or more of the examples disclosed above, in some examples, the object is in the environment of the vehicle.

Some examples of the disclosure are directed to a non-transitory computer-readable medium including instructions, which when executed by one or more processors, cause the one or more processors to perform a method comprising: receiving image data from a first camera mounted on a vehicle, the vehicle including an element configured to open into a space external to the vehicle, and the image data indicative of a motion of the first camera with respect to an environment of the vehicle; and determining whether an object, external to the vehicle, will interfere with the opening of the element into the space, the determination based on the motion, indicated in the image data, of the first camera with respect to the environment of the vehicle.

Some examples of the disclosure are directed to a vehicle comprising: a first camera; one or more processors coupled to the first camera; a door actuator coupled to the one or more processors; an element configured to open, using the door actuator, into a space external to the vehicle; and a memory including instructions, which when executed by the one or more processors, cause the one or more processors to perform a method comprising: receiving image data from the first camera, the image data indicative of a motion of the first camera with respect to an environment of the vehicle; and determining whether an object, external to the vehicle, will interfere with the opening of the element into the space, the determination based on the motion, indicated in the image data, of the first camera with respect to the environment of the vehicle.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A system comprising:
one or more processors; and
a memory including instructions, which when executed by the one or more processors, cause the one or more processors to perform a method comprising:
receiving image data from a first camera mounted on a vehicle, the vehicle including an element configured to open into a space external to the vehicle, and the image data indicative of a motion of the first camera with respect to an environment of the vehicle; and
determining whether an object, external to the vehicle, will interfere with the opening of the element into the space, the determination based on the motion, indicated in the image data, of the first camera with respect to the environment of the vehicle.

2. The system of claim 1, wherein the element comprises a door configured to open into an interaction space external to the vehicle.

3. The system of claim 1, wherein determining whether the object will interfere with the opening of the element into the space comprises:
generating a depth from motion map of the environment of the vehicle using the image data, the depth from motion map including the object;
in accordance with a determination that the object, in the depth from motion map, is within the space into which the element is configured to open, determining that the object will interfere with the opening of the element into the space; and
in accordance with a determination that the object, in the depth from motion map, is not within the space into which the element is configured to open, determining that the object will not interfere with the opening of the element into the space.

4. The system of claim 3, wherein generating the depth from motion map comprises:
in accordance with a determination that the vehicle will likely stop within a time threshold, generating the depth from motion map; and
in accordance with a determination that the vehicle will not likely stop within the time threshold, forgoing generating the depth from motion map.

5. The system of claim 3, wherein generating the depth from motion map comprises:
in accordance with a determination that the vehicle is stopped, generating the depth from motion map using the image data from before the vehicle stopped; and
in accordance with a determination that the vehicle is not stopped, forgoing generating the depth from motion map.

6. The system of claim 1, wherein the first camera is substantially rear-facing on the vehicle.

7. The system of claim 1, wherein the first camera is substantially side-facing on the vehicle.

8. The system of claim 1, wherein the first camera is mounted to the element, and the motion of the first camera with respect to the environment is due to the opening of the element, independent of a movement of the vehicle.

9. The system of claim 1, wherein the motion of the first camera with respect to the environment is due to a movement of the vehicle.

10. The system of claim 1, wherein the first camera is additionally used as a side-view mirror replacement.

11. The system of claim 1, wherein the first camera is additionally used for facial recognition to grant a user access to the vehicle.

12. The system of claim 1, wherein the method further comprises:
in accordance with a determination that the object will interfere with the opening of the element into the space, preventing the opening of the element; and
in accordance with a determination that the object will not interfere with the opening of the element into the space, allowing the opening of the element.

13. The system of claim 1, wherein the method further comprises:
detecting user input for opening the element;
in response to detecting the user input:
in accordance with a determination that the object will interfere with the opening of the element into the space, partially opening the element into the space to the extent allowed by the object; and
in accordance with a determination that the object will not interfere with the opening of the element into the space, fully opening the element into the space.

14. The system of claim 1, wherein the object is in the environment of the vehicle.

15. A non-transitory computer-readable medium including instructions, which when executed by one or more processors, cause the one or more processors to perform a method comprising:
receiving image data from a first camera mounted on a vehicle, the vehicle including an element configured to open into a space external to the vehicle, and the image data indicative of a motion of the first camera with respect to an environment of the vehicle; and
determining whether an object, external to the vehicle, will interfere with the opening of the element into the space, the determination based on the motion, indicated in the image data, of the first camera with respect to the environment of the vehicle.

16. A vehicle comprising:
a first camera;
one or more processors coupled to the first camera;
a door actuator coupled to the one or more processors;
an element configured to open, using the door actuator, into a space external to the vehicle; and
a memory including instructions, which when executed by the one or more processors, cause the one or more processors to perform a method comprising:
receiving image data from the first camera, the image data indicative of a motion of the first camera with respect to an environment of the vehicle; and
determining whether an object, external to the vehicle, will interfere with the opening of the element into the space, the determination based on the motion, indicated in the image data, of the first camera with respect to the environment of the vehicle.
